(19) United States
(12) Patent Application Publication
(10) Pub. No.: US 2021/0089541 A1
(43) Pub. Date: Mar. 25, 2021

(54) INTELLECTUAL PROPERTY SUPPORT DEVICE, INTELLECTUAL PROPERTY SUPPORT METHOD, AND INTELLECTUAL PROPERTY SUPPORT PROGRAM

(71) Applicants: Makoto ONIZUKA, Osaka (JP); Wataru HIROTA, Osaka (JP); Takashi MIKAMI, Tokyo (JP); Hajime SHIRASAKA, Tokyo (JP)

(72) Inventors: Makoto ONIZUKA, Osaka (JP); Wataru HIROTA, Osaka (JP); Takashi MIKAMI, Tokyo (JP); Hajime SHIRASAKA, Tokyo (JP)

(21) Appl. No.: 17/111,930

(22) Filed: Dec. 4, 2020

Related U.S. Application Data
(63) Continuation of application No. PCT/JP2019/021073, filed on May 28, 2019.

(30) Foreign Application Priority Data
Jun. 12, 2018 (JP) 2018-112348

(51) Int. Cl. G06F 16/2455; G06F 16/14; G06N 3/04

(52) U.S. Cl. CPC G06F 16/24564; G06N 3/0454; G06F 16/2456; G06F 16/144

(57) ABSTRACT

An intellectual property support device is disclosed comprising a reception unit configured to receive technical information representing an evaluation object; a storage unit configured to store other technical information including at least one of incidental technical information, prior art information, and similar technical information detected on the basis of the technical information and intellectual property information including document information; a calculation unit configured to set a technical wording included in the technical information as a query and to calculate a new query representing a technical wording included in the other technical information or the intellectual property information using the set query at the time of performing a labeling process on the technical information and the other technical information or the intellectual property information; and a detection unit configured to detect document information associated with the evaluation object from the intellectual property information using the query and the new query.

### CROSS-REFERENCE TO RELATED APPLICATIONS

This application is a continuation of International Patent Application No. PCT/JP2019/021073, filed May 28, 2019, which claims the benefit of priority to Japanese Patent Application No. 2018-112348, filed Jun. 12, 2018, the content of each of which is incorporated herein by reference in its entirety.

### TECHNICAL FIELD

The present invention relates to an intellectual property support device, an intellectual property support method, and an intellectual property support program that carry out procedures associated with intellectual property.

### BACKGROUND

Recently, devices that evaluate an invention for which an application has not yet been filed have been developed. Patent Literature 1 discloses a device that calculates patent right acquirability of an invention, that is, a device that calculates a new keyword which corresponds to a part which is subjected to distance movement in which a distance in projection of machine learning is not rejected and which is to be added to the invention and that outputs the new keyword using a character.

### CITATION LIST

### Patent Literature

Patent Literature 1: Japanese Patent No. 6306786

### SUMMARY

### Technical Problem

In evaluating an invention for which an application has not yet been filed, there is demand for evaluation which is more accurate, that is, which is closer to an actual examination result.

Therefore, an object of the invention is to provide a device that can enable evaluation which is closer to an actual examination result.

### Solution to Problem

According to an embodiment of the invention, there is provided an intellectual property support device including: a reception unit configured to receive technical information representing an evaluation object; a storage unit configured to store other technical information including at least one of incidental technical information incidental to the technical information, prior art information received by the reception unit, and similar technical information detected on the basis of the technical information and intellectual property information including a plurality of pieces of document information; a calculation unit configured to set a technical wording included in the technical information as a query and to calculate a new query representing a technical wording included in the other technical information or the intellectual property information using the set query at the time of performing a labeling process on the technical information and the other technical information or the intellectual property information; and a detection unit configured to detect document information associated with the evaluation object from the intellectual property information using the query and the new query.

In the intellectual property support device according to the embodiment of the invention, the calculation unit may detect definitional information included in the incidental technical information through a process which is different from the labeling process and calculate the definitional information as a candidate for the new query.

The intellectual property support device according to the embodiment of the invention may further include an evaluation unit configured to evaluate the technical information by comparison between the technical information and the document information included in the intellectual property information, and the evaluation unit may perform the evaluation using the new query.

In the intellectual property support device according to the embodiment of the invention, the storage unit may store character information, the intellectual property support device may further include an output unit configured to output a character to a user terminal which is operated by a user on the basis of the character information stored in the storage unit, the reception unit may receive evaluation information of the user, and the calculation unit may control the number of calculated new queries on the basis of the evaluation information.

In the intellectual property support device according to the embodiment of the invention, a label propagation method may be used in the labeling process.

According to an embodiment of the invention, there is provided an intellectual property support method including: a step of receiving technical information representing an evaluation object; a step of storing other technical information including at least one of incidental technical information incidental to the technical information, received prior art information, and similar technical information detected on the basis of the technical information and intellectual property information including a plurality of pieces of document information; a step of setting a technical wording included in the technical information as a query and calculating a new query representing a technical wording included in the other technical information or the intellectual property information using the set query at the time of performing a labeling process on the technical information and the other technical information or the intellectual property information; and a step of detecting document information associated with the evaluation object from the intellectual property information using the query and the new query.

According to an embodiment of the invention, there is provided an intellectual property support program causing a computer to realize: a reception function of receiving technical information representing an evaluation object; a storage function of storing other technical information including at least one of incidental technical information incidental to the technical information, prior art information received by the reception function, and similar technical information detected on the basis of the technical information and intellectual property information including a plurality of pieces of document information; a calculation function of setting a technical wording included in the technical information as a query and calculating a new query representing a technical wording included in the other technical information or the intellectual property information using the set query at the time of performing a labeling process on the technical information and the other technical information or the intellectual property information; and a detection function of detecting document information associated with the evaluation object from the intellectual property information using the query and the new query.

### Advantageous Effects of Invention

According to the invention, it is possible to enable evaluation which is closer to an actual examination result.

### BRIEF DESCRIPTION OF THE DRAWINGS

FIG. 1 is a diagram illustrating an example of a configuration of an intellectual property system according to an embodiment of the invention;

FIG. 2 is a flowchart illustrating an example of an operation of an intellectual property support device according to an embodiment of the invention;

FIG. 3 is a flowchart illustrating an example of an operation of an intellectual property support device according to an embodiment of the invention;

FIG. 4 is a diagram illustrating a process flow in Example 1 of the invention;

FIG. 5 is a diagram illustrating an algorithm in Example 1 of the invention;

FIG. 6A is a diagram illustrating details of an algorithm in Example 1 of the invention;

FIG. 6B is a diagram illustrating details of an algorithm in Example 1 of the invention;

FIG. 7 is a diagram illustrating an algorithm in Example 2 of the invention;

FIG. 8 is a diagram illustrating an example of a form which is output to a user terminal according to an embodiment of the invention; and

FIG. 9 is a diagram illustrating an example result display screen for displaying a result from the intellectual property support device to a user terminal.

### DETAILED DESCRIPTION

An embodiment of the present invention will be described below with reference to the accompanying drawings.

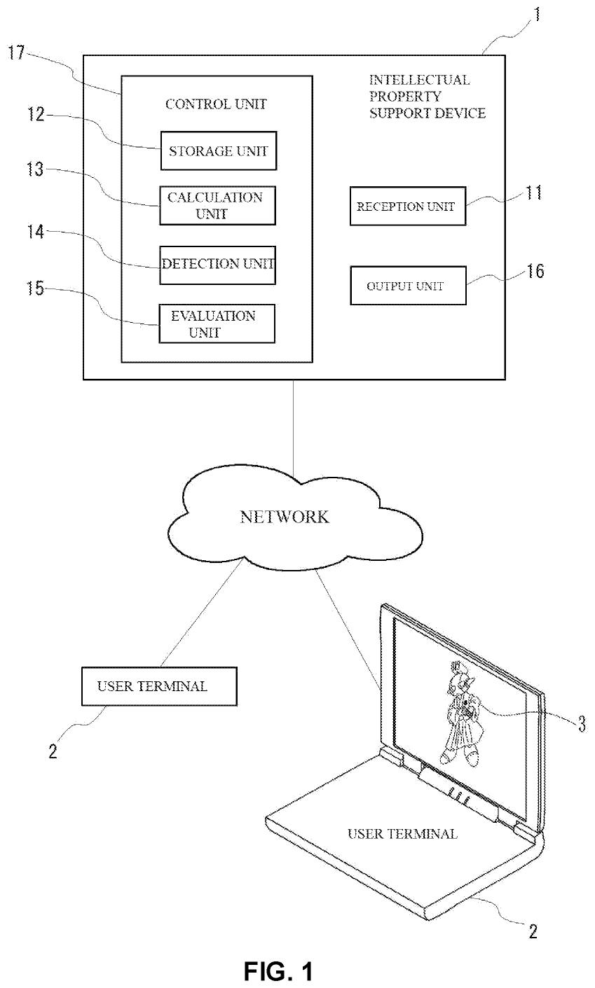

FIG. 1 is a diagram illustrating an example of a configuration of an intellectual property system. As illustrated in FIG. 1, in the intellectual property system, an intellectual property support device 1 and a user terminal 2 are connected to each other via a network (hereinafter referred to as “NW”).

The intellectual property support device 1 includes a reception unit 11, a storage unit 12, a calculation unit 13, a detection unit 14, an evaluation unit 15, an output unit 16, and a control unit 17.

The intellectual property support device 1 is a device that is connected to a user terminal 2 via the NW and provides a service of an intellectual property system to the user terminal 2. The intellectual property support device 1 is, for example, a so-called server device or a computer (for example, a desktop, a laptop, or a tablet). In the embodiment of the invention, the intellectual property support device 1 is not limited thereto.

The reception unit 11 receives various types of information which are transmitted from the user terminal 2. Specifically, the reception unit 11 can receive technical information representing an evaluation object and prior art information which are transmitted from the user terminal 2. The reception unit 11 may receive evaluation information from a user. The reception unit 11 may receive information from the user terminal 2 via character information 3 which will be described later.

Technical information is information representing details of a technique which is an evaluation object and is information including keywords from which technical details can be identified. For example, technical information is information on research or information on intellectual property. Information on research may be an original draft of a paper or may be a document such as a memo in which information on research is described, a keyword associated with research, or a paper which has been made or which is being made.

Information on intellectual property may be an original draft of an application for trademark registration, an application for design registration, an application for a patent, an application for utility model registration, or the like or may be a memo in which information on intellectual property is described, a keyword associated with intellectual property, or a document of an application for trademark registration, an application for design registration, an application for a patent, an application for utility model registration, or the like which has been made or which is being made.

Technical information is text information with a predetermined form, information without a predetermined form like a memo such as technical summary or a schematic diagram, sound information, or image information and has only to be data which can be transmitted via the NW.

Evaluation information from a user is information on evaluation of the intellectual property support device 1 from the user. Examples thereof include document information detected by the detection unit 14 which will be described later and information on evaluation of validity of an evaluation result by the evaluation unit 15 which will be described later from a user.

By receiving evaluation information from a user, the evaluation information can be used for the intellectual property support device 1. Specifically, it is possible to improve feedback of information output from the intellectual property support device 1 and machine learning and functions in the intellectual property support device 1 based thereon on the basis of the evaluation information and to enable evaluation which is closer to an actual examination result.

The reception unit 11 may receive information by outputting a format stored in the storage unit 12 which will be described later to the user terminal 2 via the output unit 16 which will be described later and allowing a user to input technical information to the format. For example, a format which is output from the output unit 16 may be an upload screen having a function of uploading data and allow a user to upload data on technical information thereto. For example, a format which is output from the output unit 16 may include information required for a patent application such as Solution to Problem and Advantageous Effects of Invention as an entry.

By employing such a format, the intellectual property support device 1 can more clearly determine which information in the technical information transmitted from the user terminal 2 to transmit and how to transmit the information at the time of transmission of information from a user to the intellectual property support device 1, and the user can more easily transmit the technical information to the intellectual property support device 1. By employing such a format, the intellectual property support device 1 can more clearly determine which information in the technical information transmitted from the user terminal 2 to transmit and how to transmit the information at the time of transmission of information from a user to the intellectual property support device 1, and it is possible to facilitate collection of information required for calculation in the calculation unit 13 which will be described later and to more easily and accurately calculate a query.

The storage unit 12 stores various types of information in the intellectual property support device 1. The storage unit 12 has a function of storing various programs and data required for operation of the intellectual property support device 1. The storage unit 12 is a recording medium such as a hard disc drive (HDD), a solid state drive (SSD), and a flash memory.

Specifically, the storage unit 12 can store incidental technical information incidental to technical information, prior art information received via the reception unit 11, similar technical information detected on the basis of technical information, intellectual property information, character information 3 which will be described later, and the like.

The incidental technical information incidental to technical information is information representing details of a technique incidental to technical information representing an evaluation object which is transmitted from the user terminal 2 and is information including keywords for identifying technical details of technical information representing an evaluation object. For example, the incidental technical information incidental to technical information is information representing more details of research which is associated with technical information representing an evaluation object and information on research. Alternatively, the incidental technical information incidental to technical information is information representing details of intellectual property which is associated with technical information representing an evaluation object and information on intellectual property.

The information representing more details of research may be an original draft of a paper or may be a document such as a memo in which information on research is described, a keyword associated with research, or a paper which has been made or which is being made. The information representing more details of research may be an original draft of an application for trademark registration, an application for design registration, an application for a patent, an application for utility model registration, or the like or may be a memo in which information on intellectual property is described, a keyword associated with intellectual property, or a document of an application for trademark registration, an application for design registration, an application for a patent, an application for utility model registration, or the like which has been made or which is being made.

Specifically, when technical information representing an evaluation object which is transmitted from the user terminal 2 is used as the gist, the incidental technical information incidental to technical information may be information representing details of a technique supplementing the gist. For example, when technical information representing an evaluation object is a keyword associated with research, the incidental technical information incidental to the technical information may be detailed information associated with the research. For example, when technical information representing an evaluation object is description of the claims associated with a patent application, the incidental technical information incidental to technical information may be description in the specifications and drawings associated with the patent application.

The incidental technical information incidental to technical information is text information with a predetermined form, information without a predetermined form like a memo such as technical summary or a schematic diagram, sound information, or image information and has only to be data which can be transmitted via the NW.

The prior art information received via the reception unit 11 is information representing details of a prior art which is transmitted from the user terminal 2 in association with technical information representing an evaluation object. For example, the prior art information is information on research or information on intellectual property which is associated with technical information representing an evaluation object and which was published in the past. The information on research which was published in the past may be a document about the research which was carried out in the past or a paper which was published on a web site, in a journal, or the like. The information on intellectual property which was published in the past may be a publication associated with an application for trademark registration, an application for design registration, an application for a patent, an application for utility model registration, or the like or may be a document of an application for trademark registration, an application for design registration, an application for a patent, an application for utility model registration, or the like which was filed in the past.

Specifically, the prior art information may be a document which is described in a paper which is technical information representing an evaluation object. The prior art information may be citations which are described in a document of a patent application which is technical information representing an evaluation object.

The similar technical information detected on the basis of technical information is information representing details of a technique which is similar to the technical information and which is detected on the basis of the technical information representing an evaluation object and is document information associated with the evaluation object detected by the detection unit 14 which will be described later.

The intellectual property information is data associated with published technical information. For example, the intellectual property information is published information on a paper, published information on intellectual property information, published information on a patent, a design, a trademark, a utility model, or a suit, or information owned by the patent office of an individual country. More specifically, for example, published information on a patent includes an unexamined patent application publication, bibliographical items described in the unexamined patent application publication, a notification of reasons for refusal associated with the unexamined patent application publication, details of the notification of reasons for refusal, information of citations in the notification of reasons for refusal, details of a response to the notification of reasons for refusal, the number of amendments in the application associated with the unexamined patent application publication, and details of the amendments.

The character information 3 corresponds to a person or an animal appearing in fiction such as a novel, a cartoon, a movie, an animation, or a computer game on a computer or digital data representing a nature or a personality of such a character or an item represented along therewith. For example, a character of samurai illustrated in FIG. 1 or a character of a judge or an examiner may be employed. The character information 3 may be stored in the storage unit 12. As the character information 3, a single output form or a plurality of output forms for each character are recorded in the storage unit 12. Specifically, the storage unit 12 stores poses of joy, anger, grief, and pleasure representing whether an intellectual property right of a samurai character represented by the character information 3 has been acquired.

When a labeling process is performed on technical information and other technical information or intellectual property information including at least one of the incidental technical information incidental to the technical information, the prior art information received via the reception unit 11, and the similar technical information detected on the basis of the technical information, the calculation unit 13 can set a technical wording included in technical information as a query and calculate a new query representing a technical wording included in the other technical information or the intellectual property information using the set query. The calculation unit 13 may detect definitional information included in the incidental technical information through a process different from the labeling process and calculate the definitional information as a candidate for a new query. The calculation unit 13 can control the number of calculated new queries on the basis of the evaluation information from the user.

A technical wording is a sentence, a combination of a plurality of phrases or clauses, a phrase or a clause, or a word.

The labeling process is a process of accepting information included in the technical information, the other technical information, or the like. The information included in the technical information, the other technical information, or the like is, for example, a keyword or a technical wording representing details of the technical information. A label propagation algorithm may be used as the labeling process.

Definitional information is information such as a sentence, a combination of a plurality of phrases or clauses, a phrase or a clause, or a word which is included in the incidental technical information incidental to technical information and which defines a technical wording included in the technical information. For example, the definitional information is explanation of a technical wording which is described in the incidental technical information for the technical wording included in the technical information. Specifically, when a technical wording included in technical information is a word included in description of the claims associated with a patent application, explanation of the word described in the specification associated with the patent application may be used as the definitional information.

The detection unit 14 can detect document information associated with an evaluation object from intellectual property information using the query set by the calculation unit 13 and the new query calculated by the calculation unit 13.

The document information associated with an evaluation object is information on a document associated with technical information representing the evaluation object. For example, the document information associated with an evaluation object is a document associated with the evaluation object, a technical wording included in the document, or data on the document. The document associated with an evaluation object may be information on a document associated with some or all of the technical information representing the evaluation object. For example, the document information associated with an evaluation object is information described in a document associated with a paper, an application for trademark registration, an application for design registration, an application for a patent, an application for utility model registration, or the like. Specifically, the document information associated with an evaluation object may be information of text or drawings described in a paper or information of text or drawings described in a publication associated with an application for trademark registration, an application for design registration, an application for a patent, or an application for utility model registration.

The document information detected by the detection unit 14 can be output to the user terminal 2 by the output unit 16 which will be described later. The output document information may be data of the document itself or information representing the document. For example, the output document information is data of a document associated with a paper, an application for trademark registration, an application for design registration, an application for a patent, or an application for utility model registration, or identification information such as a numeral or a title added to the document associated with a paper, an application for trademark registration, an application for design registration, an application for a patent, or an application for utility model registration.

When a labeling process is performed on technical information and other technical information or intellectual property information including at least one of the incidental technical information incidental to the technical information, the prior art information received via the reception unit 11, and the similar technical information detected on the basis of the technical information, the calculation unit 13 can set a technical wording included in technical information as a query and calculate a new query representing a technical wording included in the other technical information or the intellectual property information using the set query and the detection unit 14 can detect document information associated with an evaluation object from the intellectual property information using the query set by the calculation unit 13 and the new query calculated by the calculation unit 13. Accordingly, it is possible to enable evaluation which is closer to an actual examination result. That is, it is possible to enable detection of document information associated with each technical wording included in technical information representing an evaluation object for the technical information, to enable detection of document information including technical wordings which are different wordings and which represent the same meaning, and to enable evaluation which is closer to an actual examination result.

Since the calculation unit 13 can detect definitional information included in the incidental technical information through a process different from the labeling process and calculate the definitional information as a candidate for the new query, it is possible to reduce the number of processes which are performed by the intellectual property support device 1, to facilitate detection of document information including technical wordings which are different wordings and which represent the same meaning, and to enable evaluation which is closer to an actual examination result while reducing a load of the intellectual property support device 1.

Since the calculation unit 13 can control the number of calculated new queries on the basis of evaluation information from a user, it is possible to enable calculation using information with higher accuracy such as evaluation information from a user and to enable evaluation which is closer to an actual examination result.

The evaluation unit 15 can evaluate technical information by comparing the technical information representing an evaluation object received via the reception unit 11 with the document information included in the intellectual property information detected by the detection unit 14. The evaluation unit 15 can perform the evaluation using the new query calculated by the calculation unit 13. For example, in association with the new query calculated by the calculation unit 13, the evaluation unit 15 may compare the technical information representing an evaluation object received via the reception unit 11 with the document information included in the intellectual property information detected by the detection unit 14 and evaluate a degree of coincidence therebetween.

The evaluation unit 15 may calculate a degree of coincidence between technical wordings included in the technical information representing an evaluation object and the document information included in the intellectual property information as a score, determine whether they coincide with each other using a threshold value process, and calculate coincidence and difference therebetween. The threshold value may be determined in advance or a score calculated by machine learning may be employed.

The evaluation unit 15 may generate learning data which is used for machine learning in advance using the intellectual property information stored in the storage unit 12 and evaluate the technical information representing an evaluation object on the basis of the learning data and the intellectual property information.

The evaluation unit 15 may evaluate the technical information representing an evaluation object using a model which is acquired by machine learning using the intellectual property information stored in the storage unit 12.

The intellectual property information which is used for the machine learning may be digitized in advance and then processed for each item in the intellectual property information, and the technical information representing an evaluation object received from the user terminal 2 may be digitized and then evaluated in the same way.

The items in the intellectual property information which are digitized in advance may be various types of information which are correlated with a publication associated with intellectual property. Various types of information which are correlated with a publication associated with intellectual property may be, for example, a publication date of an unexamined patent application, a filing date of application documents (that is, an application date) associated with the publication, the number of notifications of reasons for refusal received in the application associated with the publication, details of the notification of reasons for refusal, details of a response to the notification of reasons for refusal, the number of amendments performed in the application associated with the publication, details of the amendments, the number of characters in an independent claim, or the number of claims.

The evaluation unit 15 may store actual results of technical information representing known evaluation objects which were evaluated in the past by the intellectual property support device 1 as feedback in the storage unit 12, and use the stored results for machine learning. Accordingly, the intellectual property support device 1 can perform evaluation with higher accuracy.

Evaluation in the evaluation unit 15 can include acquirability of an intellectual property right.

Since the evaluation unit 15 can evaluate technical information by comparison between the technical information representing an evaluation object received via the reception unit 11 and the document information included in the intellectual property information detected by the detection unit 14 using the new query calculated by the calculation unit 13, it is possible to enable evaluation which is closer to an actual examination result. That is, it is possible to enable comparison and evaluation of document information including technical wordings which are different wordings and which represent the same meaning and the technical information representing an evaluation object and to enable evaluation which is closer to an actual examination result.

The output unit 16 outputs various types of information in the intellectual property support device 1 to the user terminal 2. Specifically, the output unit 16 can output the character information 3 to a user terminal 2 which can be operated by a user on the basis of the character information 3 stored in the storage unit 12. The output unit 16 can output the document information detected by the detection unit 14 to the user terminal 2. The output unit 16 can output a result of evaluation from the evaluation unit 15 to the user terminal 2.

The output unit 16 may output a result of evaluation from the evaluation unit 15 to the user terminal 2 using the character information 3 output from the output unit 16. The result of evaluation from the evaluation unit 15 output by the output unit 16 may be, for example, a mock notification of reasons for refusal (a mock notification similar to a notification of reasons for refusal) or a comparison table between the technical information representing an evaluation object and the document information detected by the detection unit 14.

Since the output unit 16 can output various types of information to the user terminal 2 using the character information 3, the intellectual property support device 1 can simply provide a user with information acquired by the intellectual property support device 1 such that the user can easily understand the information and even a user with little knowledge about a technique can easily obtain information on the technique.

The control unit 17 is a processor having a function of controlling the constituents of the intellectual property support device 1. For example, the control unit 17 is a central processing unit, a microprocessor, a processor core, a multiprocessor, an application-specific integrated circuit (ASIC), or a field programmable gate array (FPGA). In the invention, the control unit 17 is not limited to such examples.

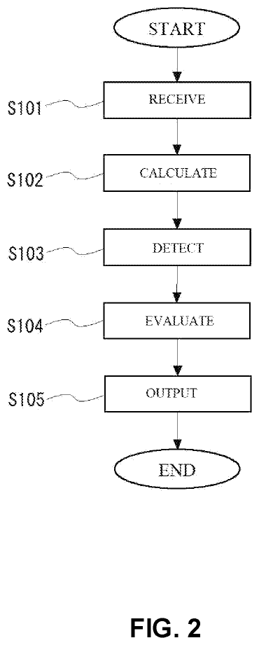

FIG. 2 is a flowchart illustrating an example of an operation of the intellectual property support device 1 according to the embodiment of the invention.

As illustrated in FIG. 2, when the intellectual property support device 1 is connected to a user terminal 2 via the NW, the reception unit 11 receives various types of information by outputting various types of information stored in the storage unit 12 from the output unit 16 to the user terminal 2 and receiving various types of information from the user terminal 2 (S101). Specifically, the intellectual property support device 1 outputs a screen for receiving technical information representing an evaluation object, character information 3, and the like from the output unit 16 to the user terminal 2 and the reception unit 11 may receive the information by receiving technical information representing an evaluation object, incidental technical information, prior art information, and the like from the user terminal 2.

Subsequently, when a labeling process is performed on the technical information representing an evaluation object received by the reception unit 11, the incidental technical information incidental to technical information and stored in the storage unit 12, the prior art information received via the reception unit 11, similar technical information detected on the basis of the technical information, and intellectual property information, a technical wording included in the technical information is set as a query and a new query representing the technical wording included in other technical information is calculated using the set query (S102). Alternatively, the calculation unit 13 may detect definitional information included in the incidental technical information through a process different from the labeling process and calculate the definitional information as a candidate for the new query (S102).

The detection unit 14 can detect document information associated with the evaluation object from the intellectual property information using the query set by the calculation unit 13 and the new query calculated by the calculation unit 13 (S103).

The evaluation unit 15 evaluates the technical information representing the evaluation object received by the reception unit 11 by comparing the technical information representing an evaluation object received by the reception unit 11 with the document information included in the intellectual property information detected by the detection unit 14 (S104). The evaluation unit 15 can perform the evaluation using the new query calculated by the calculation unit 13.

The output unit 16 outputs the document information detected by the detection unit 14 and a result of evaluation from the evaluation unit 15 to the user terminal 2 (S105). At this time, the output unit 16 may output the character information 3 to the user terminal 2 on the basis of the character information 3 stored in the storage unit 12. The output unit 16 may output the result of evaluation from the evaluation unit 15 to the user terminal 2 using the character information 3 output by the output unit 16.

With this configuration, it is possible to enable evaluation which is closer to an actual examination result. That is, it is possible to enable detection of document information associated with each technical wording included in technical information representing an evaluation object for the technical information, to enable detection of document information including technical wordings which are different wordings and which represent the same meaning, and to enable evaluation which is closer to an actual examination result.

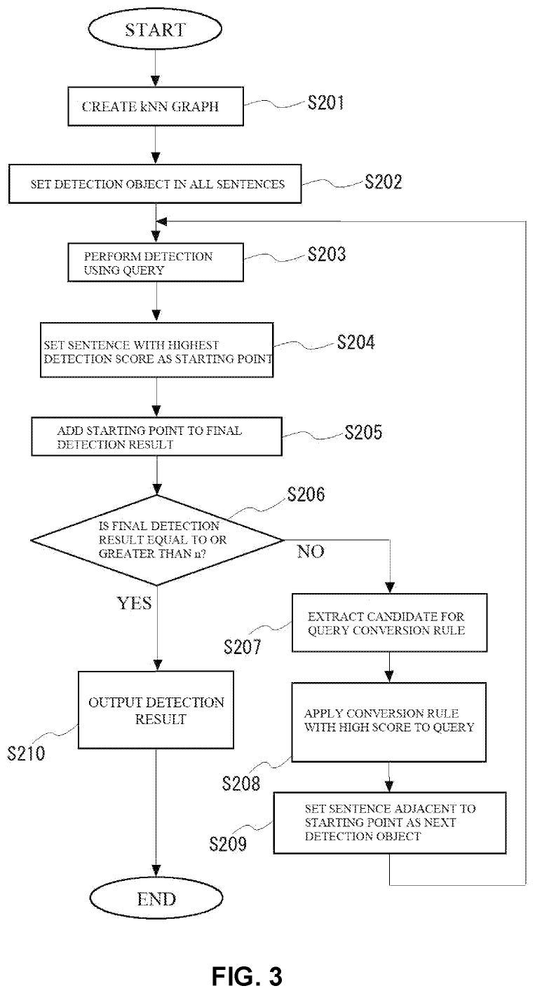

FIG. 3 is a flowchart illustrating an example of the operations of the calculation unit 13 and the detection unit 14 in the intellectual property support device 1 according to the embodiment of the invention.

When the reception unit 11 receives technical information representing an evaluation object, the calculation unit 13 first creates a kNN graph (S201). The kNN graph is created in the following order. First, all sentences included in the incidental technical information incidental to technical information, the prior art information received via the reception unit 11, the similar technical information detected on the basis of technical information, and the intellectual property information which are stored in the storage unit 12 are vectorized. This vectorization may be performed using the related art such as Word2Vec or Doc2Vec. A distance matrix between sentences is created from the vectors. With each sentence as a vertex, lines are drawn from text data to k sentences with short distances therefrom. Through the aforementioned order, the kNN graph is created. While sentences have been exemplified, a combination of a plurality of phrases or clauses, a phrase or a clause, or a word may be used.

Subsequently, the calculation unit 13 sets a detection object of the technical information received from the reception unit 11 in all sentences included in the incidental technical information incidental to technical information, the prior art information received via the reception unit 11, the similar technical information detected on the basis of technical information, and the intellectual property information which are stored in the storage unit 12 (S202) and sets a technical wording included in the technical information received from the reception unit 11 as a query, and the detection unit 14 detects the detection object using the query (S203). Here, the detection may be performed using the related art such as Elastic Search (registered trademark).

The detection unit 14 sets a sentence with a highest detection score as the result of detection as a starting point (S204), adds the starting point to a final detection result (S205), and repeatedly performs these processes until the final detection result reaches n (S206). The process flow progresses to S207 when the final detection result does not reach n, and the process flow progresses to S210 when the final detection result becomes equal to or greater than n.

When the final detection result does not reach n, the calculation unit 13 extracts a candidate for a query conversion rule (S207). The candidate for a query conversion rule is extracted in the following procedure. First, a sentence similar to the sentence set as the starting point is extracted on the basis of the created kNN graph. Then, a word accepted to have a high degree of importance is extracted from the sentence set as the starting point and the extracted similar sentence. Acceptance of the degree of importance may be performed using the related art such as a TF-IDF method. Words adjacent to the extracted word in the sentence set as the starting point and the extracted similar sentence are acquired. For example, such words are “file” and “process” when the extracted word is “distribution” and the sentence is “a distribution process in a distributed file system.”

The calculation unit 13 applies a conversion rule with a high score to the query (S208). The number of conversion rules may be one or more, and the number may be controlled by the calculation unit 13. The number of new queries which are calculated using the conversion rule may be controlled by the calculation unit 13 on the basis of evaluation information from a user in response to the result of evaluation of the technical information representing an evaluation object which is received by the reception unit 11. The score can be calculated using the following expression/equation.

$$score ( w 1 , w 2 ) = \frac{P ( w 1 , A ) \times P ( w 2 , B )}{P ( w 1 , B ) \times P ( w 2 , A )} \times similarity ( w 1 , w 2 ) \qquad Equation 1$$

In the expression (Equation 1 above), a sentence set as a starting point is defined as A, an adjacent word acquired in the sentence set as a starting point is defined as w1, an extracted similar sentence is defined as B, an adjacent word acquired in the extracted similar sentence is defined as w2, and an appearance probability of a word w in a sentence X is defined as P(w, X). The term “similarity” is an index indicating a semantic closeness between words and a greater value thereof means that two words are semantically close to each other. The term “similarity” can be set to a value which is calculated on the basis of a path length of WordNet by nltk which is a package of Python.

The calculation unit 13 sets a sentence adjacent to the starting point as a next detection object (S209) and performs detection again using the new query calculated in S208 (the process flow returns to S203).

When the final detection result becomes equal to or greater than n, the detection result is output (S210). At this time, the detection unit 14 may detect document information including the sentence serving as the starting point in the final detection result or document information.

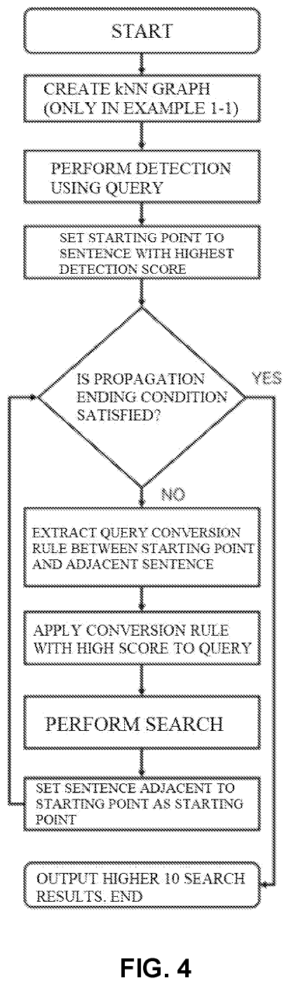

The calculation unit 13 may perform the process flow illustrated in FIG. 4. Details of the process flow illustrated in FIG. 4 will be described below.

Methods in the following examples are methods of performing patent search while converting a query in a propagation manner. The same concept is often expressed by different terms in different patents, which is one factor for making patent search difficult. Therefore, in the following examples, a difference in expression between patents and between patent groups is detected and search is performed by reflecting the detected difference in expression in the query.

Two examples will be described below. In a first example, a difference in expression between patents is detected. In a second example, a difference in expression between patent groups is detected.

### Example 1

Example 1 is a method of detecting a difference in expression between patents and reflecting the detected difference in expression in a query. This example is additionally classified into two examples depending on a difference in method of searching the vicinity of a sentence.

Example 1-1: a method of graphing a relationship of closeness between sentences in advance (graphing in a kNN graph)

Example 1-2: a method of determining the closeness between sentences at the time of execution (applying a kNN method at the time of execution)

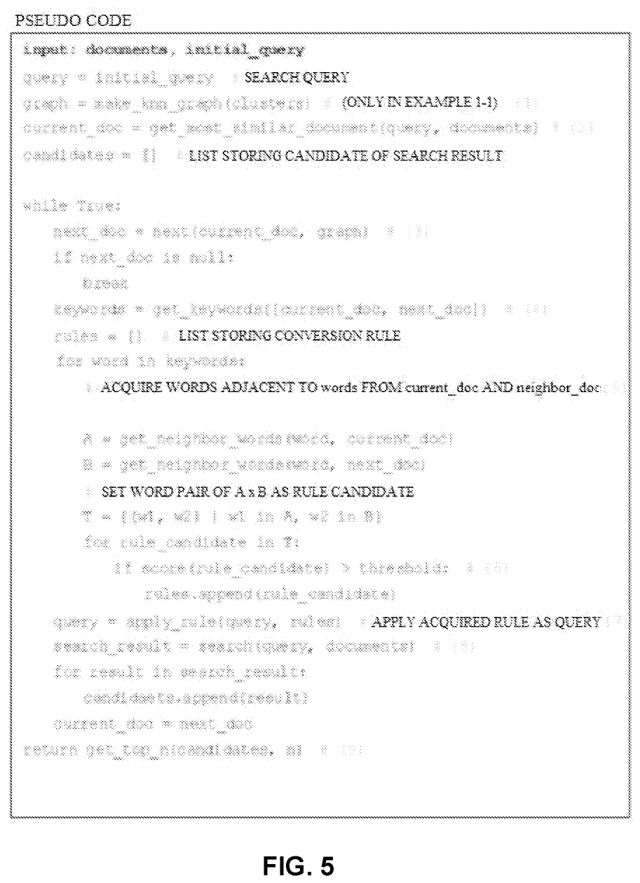

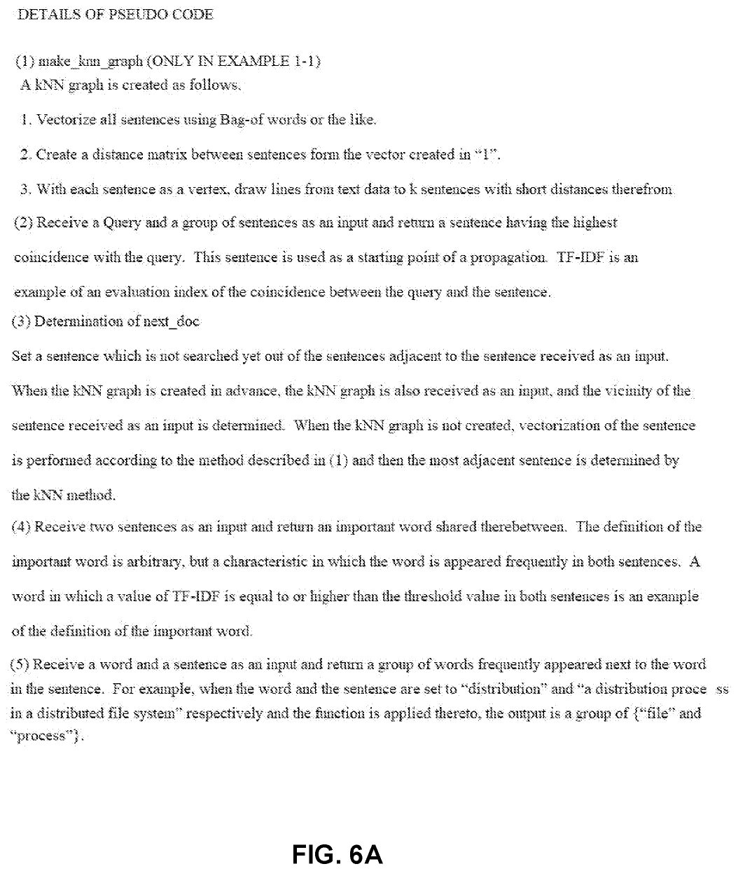

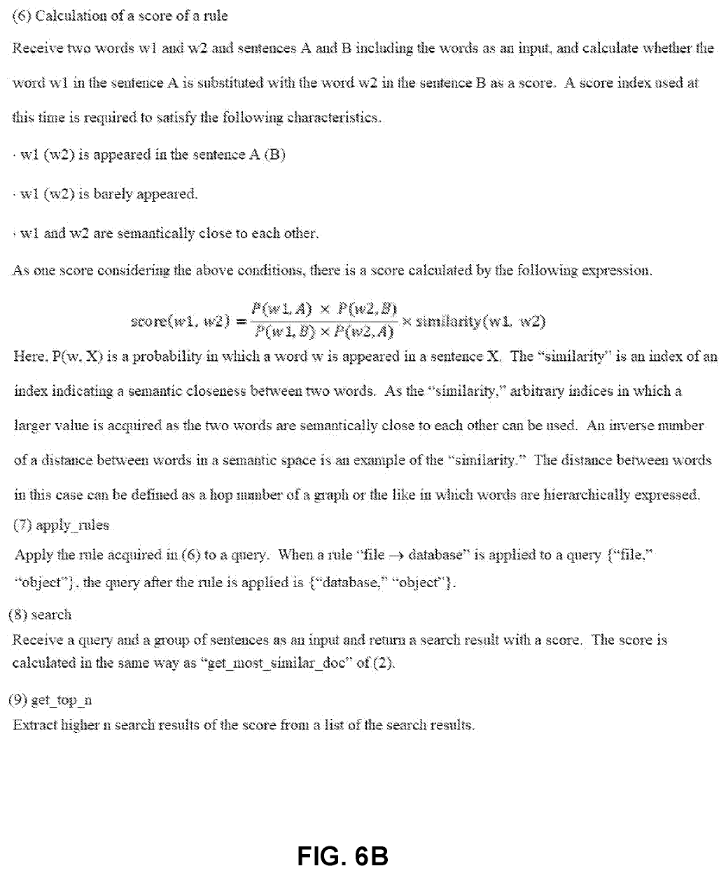

The calculation unit 13 may use an algorithm illustrated in FIG. 5. Details of FIG. 5 are illustrated in FIGS. 6A and 6B.

### Example 2

In Example 2, unlike Example 1, a difference in expression between patent groups, instead of between patents, is detected. Inputting and outputting of an algorithm are the same as in Example 1. Similar to Example 1, Example 2 is classified into two methods including a method of determining the closeness between sentences in advance and a method of determining the closeness between sentences at the time of execution.

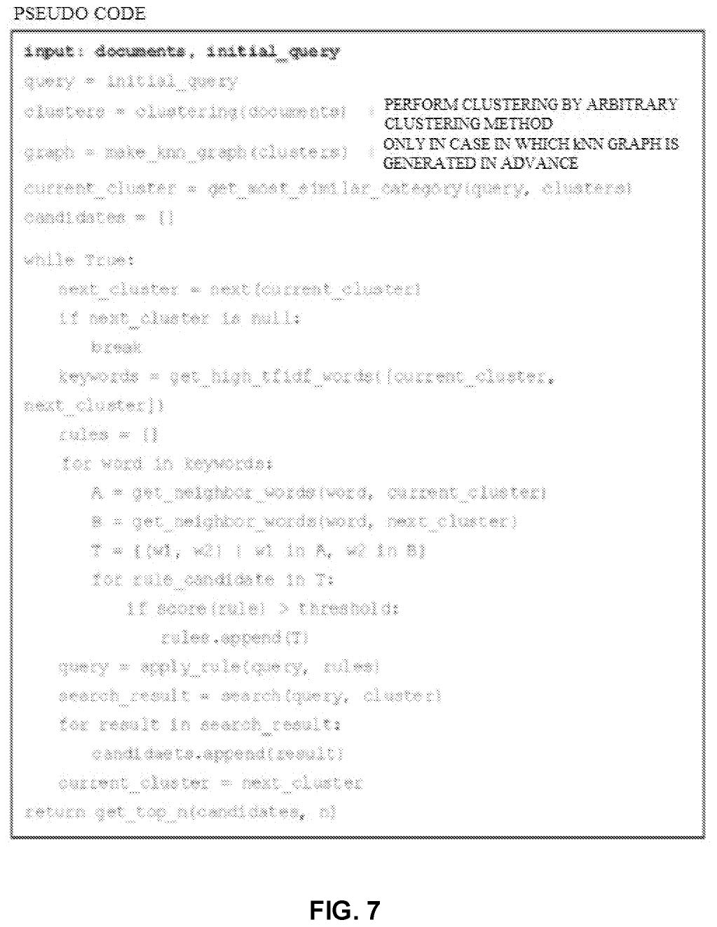

The calculation unit 13 may use an algorithm illustrated in FIG. 7.

With this configuration, it is possible to enable evaluation which is closer to an actual examination result. That is, it is possible to enable detection of document information associated with each technical wording included in technical information representing an evaluation object for the technical information, to enable detection of document information including technical wordings which are different wordings and which represent the same meaning, and to enable evaluation which is closer to an actual examination result.

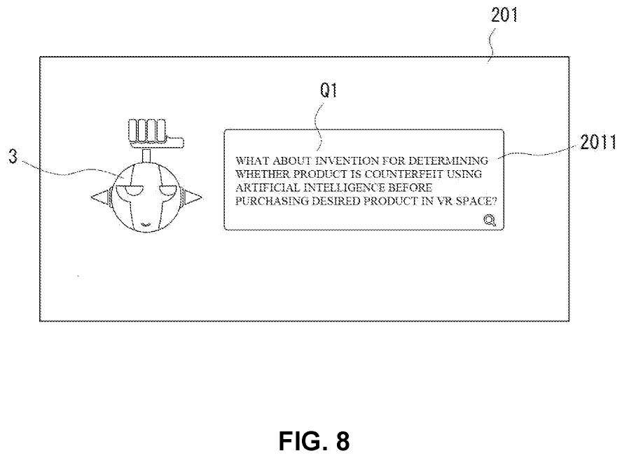

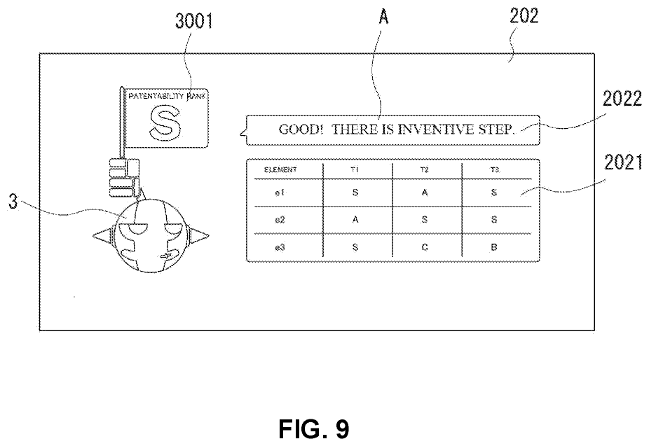

FIGS. 8 and 9 are diagrams schematically illustrating examples of a screen displayed on a user terminal 2 to transmit information to the reception unit 11 of the intellectual property support device 1.

FIG. 8 illustrates an example of an input screen 201 which is displayed on a user terminal 2 to allow the intellectual property support device 1 to receive technical information representing an evaluation object from the user terminal 2 via the NW. As illustrated in FIG. 8, an input box 2011 for allowing a user of the user terminal 2 to input technical information representing an evaluation object can be displayed on the input screen 201. At this time, the output unit 16 of the intellectual property support device 1 may output character information 3 to the input screen 201. The user can freely write technical information representing an evaluation object to the input box 2011 by operating the user terminal 2. In the example illustrated in FIG. 8, a question Q1 in a tone like asking a question of a friend, “What about invention for determining whether product is counterfeit using artificial intelligence before purchasing desired product in VR space?,” is described in the input box 2011. Details written to the input box 2011 are transmitted as technical information representing an evaluation object to the intellectual property support device 1.

FIG. 9 illustrates an example of a result display screen 202 for displaying a result output from the intellectual property support device 1 to the user terminal 2 via the NW. A result of evaluation of the technical information representing an evaluation object received from the user terminal 2 which is output from the output unit 16 of the intellectual property support device 1 can be displayed on the result display screen 202. At this time, the output unit 16 of the intellectual property support device 1 can output character information 3 to the result display screen 202. The character information 3 can be output in a variable form depending on the result of evaluation. A display example of the result display screen 202 which is displayed when it is determined as the result of evaluation from the intellectual property support device 1 that the technical information representing an evaluation object received from the user terminal 2 satisfies an inventive step is illustrated in FIG. 9.

As illustrated in FIG. 9, the intellectual property support device 1 can output information such that a character based on the character information 3, a flag 3001 based on the character information 3, a result display box 2021 for representing a result of evaluation from the evaluation unit 15, and a speech balloon 2022 for displaying details of the result of evaluation from the evaluation unit 15 as if the character uttered the details are displayed on the result display screen 202. In this example, speech contents A in an old-fashioned tone, “Good! There is inventive step,” are described in the speech balloon 2022. Character “S” is displayed large at the center of the flag 3001, and “PATENTABILITY RANK” is displayed small above character “S.”

In the result display box 2021, the intellectual property support device 1 can arrange document information T1, T2, and T3 associated with an evaluation object detected by the detection unit 14 of the intellectual property support device 1 and display a degree of similarity between the technical information representing an evaluation object and the information described in document information T1, T2, and T3 for each of technical wording e1, e2, and e3 included in the technical information. The degree of similarity may be expressed, for example, by symbols such as “S,” “A,” “B,” and “C,” as illustrated in FIG. 8, where “S,” “A,” “B,” and “C” may correspond to “not described,” “dissimilar,” “slightly similar,” and “identical.” In this example, a result representing that one technical wording e3 out of the technical wordings e1, e2, and e3 included in the technical information representing an evaluation object is identical to description in document information T2 is obtained, but the two remaining technical wordings e1 and 2 are not described in any of the document information T1, T2, and T3 and thus it is determined that they satisfy an inventive step.

Information received by the intellectual property support device 1 and information output from the intellectual property support device 1 can be stored in the storage unit 12 of the intellectual property support device 1 along with date and times thereof. The stored information can be browsed using the user terminal 2.

With this configuration, the intellectual property support device 1 can simply provide a user with information acquired by the intellectual property support device 1 such that the user can easily understand the information and even a user with short knowledge about a technique can easily obtain information on the technique.

The aforementioned configuration may include some or all of techniques described in the following documents.
[1] Application of graph compression and peak order optimization to parallel graph processing engine, Ryuichi Ito, Junya Arai, Yuuwa Sasaki, Makoto Onizuka, the Institute of Electronics, Information and Communication Engineers DEIM, 2017.
[2] Graph partitioning for distributed graph processing, Makoto Onizuka, Toshimasa Fujimori, Hiroaki Shiokawa, Data Science and Engineering, 2(1), 2017.
[3] Graph partitioning for distributed graph processing, Toshimasa Fujimori, Hiroaki Shiokawa, Makoto Onizuka, Database of Journal of Information Processing Society (TOD), 9(4) 1882-7799, 2016.
[4] Study of incremental updatable label propagation method, Kouhei Nagata, Yuuwa Sasaki, Yasuhiro Fujiwara, Makoto Onizuka, the Institute of Electronics, Information and Communication Engineers DEIM, 2018.

The description above represents an example of a representative embodiment and the invention is not limited to the embodiment.

### REFERENCE SIGNS LIST

1 . . . Intellectual property support device
2 . . . User terminal
3 . . . Character information
11 . . . Reception unit
12 . . . Storage unit
13 . . . Calculation unit
14 . . . Detection unit
15 . . . Evaluation unit
16 . . . Output unit
17 . . . Control unit

What is claimed is:

1. An intellectual property support device, comprising:
a reception unit configured to receive technical information representing an evaluation object;
a storage unit configured to store other technical information including at least one of incidental technical information incidental to the technical information, prior art information received by the reception unit, and similar technical information detected on the basis of the technical information and intellectual property information including a plurality of pieces of document information;
a calculation unit configured to set a technical wording included in the technical information as a query and to calculate a new query representing a technical wording included in the other technical information using the set query at the time of performing a labeling process on the technical information and the other technical information; and
a detection unit configured to detect document information associated with the evaluation object from the intellectual property information using the query and the new query,
wherein the calculation unit detects definitional information included in the incidental technical information through a process which is different from the labeling process and calculates the definitional information as a candidate for the new query.

2. The intellectual property support device of claim 1, further comprising an evaluation unit configured to evaluate the technical information by comparison between the technical information and the document information included in the intellectual property information, wherein the evaluation unit performs the evaluation using the new query.

3. The intellectual property support device of claim 1, wherein the storage unit stores character information, wherein the intellectual property support device further comprises an output unit configured to output a character to a user terminal which is operated by a user on the basis of the character information stored in the storage unit, and wherein the reception unit receives evaluation information of the user and the calculation unit controls the number of calculated new queries on the basis of the evaluation information.

4. The intellectual property support device of claim 1, wherein a label propagation method is used in the labeling process.

5. An intellectual property support method, comprising:
a step of receiving technical information representing an evaluation object;
a step of storing other technical information including at least one of incidental technical information incidental to the technical information, received prior art information, and similar technical information detected on the basis of the technical information and intellectual property information including a plurality of pieces of document information;
a step of setting a technical wording included in the technical information as a query and calculating a new query representing a technical wording included in the other technical information using the set query at the time of performing a labeling process on the technical information and the other technical information; and
a step of detecting document information associated with the evaluation object from the intellectual property information using the query and the new query.

6. An intellectual property support computer program, comprising:
a reception function of receiving technical information representing an evaluation object;
a storage function of storing other technical information including at least one of incidental technical information incidental to the technical information, prior art information received by the reception function, and similar technical information detected on the basis of the technical information and intellectual property information including a plurality of pieces of document information;
a calculation function of setting a technical wording included in the technical information as a query and calculating a new query representing a technical wording included in the other technical information using the set query at the time of performing a labeling process on the technical information and the other technical information; and
a detection function of detecting document information associated with the evaluation object from the intellectual property information using the query and the new query.
